(19) United States
(12) Patent Application Publication
(10) Pub. No.: US 2014/0160381 A1
(43) Pub. Date: Jun. 12, 2014

(54) 2D AND 3D SWITCHABLE DISPLAY DEVICE AND LIQUID CRYSTAL LENTICULAR LENS THEREOF

(71) Applicant: WINTEK CORPORATION, Taichung City (TW)

(72) Inventors: Wen-Chun Wang, Taichung City (TW); Chia-Hsiung Chang, Tainan City (TW); Chong-Yang Fang, Taichung City (TW); Yan-Yu Su, Changhua County (TW); Chia-Hung Yeh, Changhua County (TW); Wei-Chou Chen, Hsinchu City (TW)

(73) Assignee: WINTEK CORPORATION, Taichung City (TW)

(21) Appl. No.: 14/102,470

(22) Filed: Dec. 10, 2013

(30) Foreign Application Priority Data
Dec. 11, 2012 (TW) 101146683

(51) Int. Cl. G02B 27/22

(52) U.S. Cl. CPC G02B 27/2214
USPC 349/15; 349/200

(57) ABSTRACT

A liquid crystal lenticular lens includes a first transparent substrate, a second transparent substrate, a first transparent electrode, a second transparent electrode, a liquid crystal layer, a first alignment layer, a second alignment layer and a first electric field uniformizing layer. The first transparent electrode includes a plurality of first electrode bars disposed along a first direction and in parallel, and the first direction is non-parallel and non-perpendicular to the edges of the first transparent substrate. The first electric field uniformizing layer is disposed between the first alignment layer and the first transparent electrode or between the second alignment layer and the second transparent electrode.

### BACKGROUND OF THE INVENTION

1. Field of the Invention

The present disclosure relates to a two-dimensional and three-dimensional switchable display device and a liquid crystal lenticular lens thereof, and more particularly, to a two-dimensional and three-dimensional switchable display device and a liquid crystal lenticular lens thereof with an electric field uniformizing layer, which smoothes the refractive index change of the liquid crystal layer.

2. Description of the Prior Art

Display related technologies have progressed in recent years; stereoscopic display technologies and related applications have also developed flourishingly. The principle of the stereoscopic display technology includes delivering different images respectively to a left eye and a right eye of a viewer to give the viewer a feeling of gradation and depth in the images, thereby generating the stereoscopic effect in the cerebrum of the viewer by analyzing and overlapping the images received separately by the left eye and the right eye.

In general, the stereoscopic display technologies may be substantially divided into two major types, which are the glasses type and the naked eye type (auto stereoscopic type). The stereoscopic display effect of the glasses type stereoscopic display is generally better than the display quality of the naked eye type stereoscopic display. However, the special glasses may still cause inconvenience when wearing the glasses type stereoscopic display device. On the other hand, the naked eye type stereoscopic display device can work without special glasses. In the general naked eye type stereoscopic display technologies, such as the lenticular lens type stereoscopic display technologies, the irradiating directions of different display images are changed by lenses and the different display images are respectively guided toward the left eye or the right eye of the viewer. In the lenticular lens type stereoscopic display technologies, a liquid crystal lens, which produces the lens effect, can be formed with the refractive index change of the liquid crystal molecules. However, the refractive index change of the conventional liquid crystal lens is not smooth enough to achieve the desired optical performance as a real lens. Moreover, because the stripe electrodes of the conventional liquid crystal lens are arranged in one direction, the lens effect only occurs either when the orientation of the stereoscopic display device is landscape (i.e. along the horizontal direction) or when the orientation of the stereoscopic display device is portrait (i.e. along the vertical direction). In view of this, the effect and the application of the stereoscopic display device are restricted.

### SUMMARY OF THE INVENTION

It is one of the objectives of the disclosure to provide a liquid crystal lenticular lens with the optimized lens effect and a two-dimensional and three-dimensional switchable display device for both portrait and landscape orientation.

An embodiment of the disclosure provides a liquid crystal lenticular lens. The liquid crystal lenticular lens includes a first transparent substrate, a second transparent substrate, a first transparent electrode, a second transparent electrode, a liquid crystal layer, a first alignment layer, a second alignment layer and a first electric field uniformizing layer. The first transparent substrate has a plurality of edges. The second transparent substrate is disposed opposite to the first transparent substrate. The first transparent electrode is disposed on an inner surface of the first transparent substrate. The first transparent electrode includes a plurality of first electrode bars. The first electrode bars are parallel to each other and arranged along a first direction. The first direction is non-parallel and non-perpendicular to the edges of the first transparent substrate. The second transparent electrode is disposed on an inner surface of the second transparent substrate. The liquid crystal layer is disposed between the first transparent electrode and the second transparent electrode. The first alignment layer is disposed between the first transparent electrode and the liquid crystal layer. The first alignment layer has a first alignment direction. The first alignment direction is parallel to the first direction. The second alignment layer is disposed between the second transparent electrode and the liquid crystal layer. The second alignment layer has a second alignment direction. The first electric field uniformizing layer is disposed between the first alignment layer and the first transparent electrode or between the second alignment layer and the second transparent electrode.

Another embodiment of the disclosure provides a two-dimensional and three-dimensional switchable display device. The two-dimensional and three-dimensional switchable display device includes a display panel and the aforementioned liquid crystal lenticular lens. The display panel has a display surface. The aforementioned liquid crystal lenticular lens is disposed on the display surface of the display panel.

With the electric field uniformizing layer, the refractive index change of the liquid crystal layer can be smoothed under the three-dimensional display mode, thereby optimizing the lens effect to achieve that of a real lens.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a liquid crystal lenticular lens according to a first embodiment of the present invention.

FIG. 2 is a schematic diagram illustrating a liquid crystal lenticular lens according to a second embodiment of the present invention.

FIG. 3 is a schematic diagram illustrating a display condition of the two-dimensional and three-dimensional switchable display device according to the first embodiment under a two-dimensional display mode.

FIG. 4 is a schematic diagram illustrating a display condition of the two-dimensional and three-dimensional switchable display device according to the first embodiment under a three-dimensional display mode.

### DETAILED DESCRIPTION

To provide a better understanding of the present disclosure, features of the embodiments will be made in detail. The embodiments of the present disclosure are illustrated in the accompanying drawings with numbered elements. In addition, the terms such as “first” and “second” described in the present disclosure are used to distinguish different components or processes, which do not limit the sequence of the components or processes.

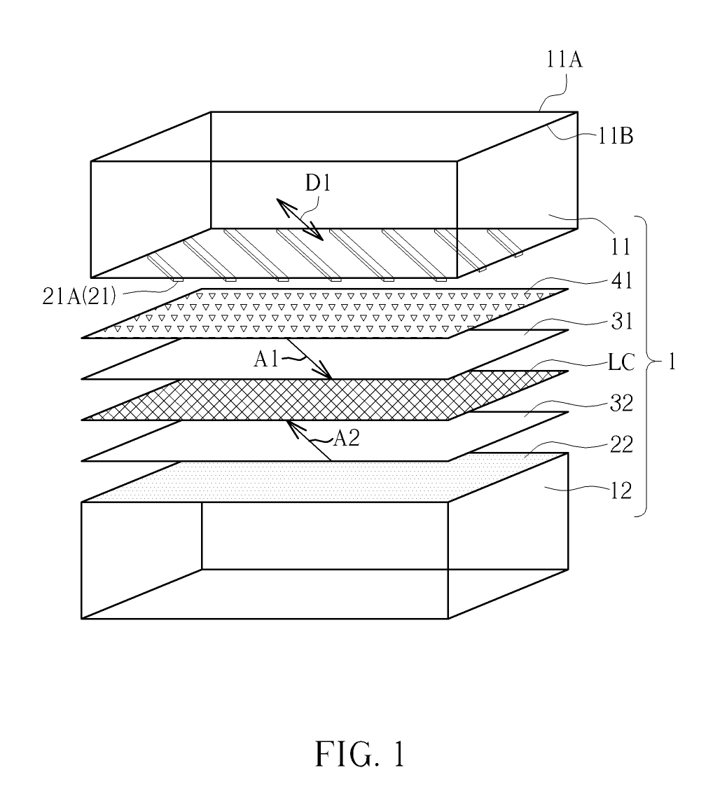

Please refer to FIG. 1. FIG. 1 is a schematic diagram illustrating a liquid crystal lenticular lens according to a first embodiment of the present invention. As shown in FIG. 1, the liquid crystal lenticular lens 1 in this embodiment includes a first transparent substrate 11, a second transparent substrate 12, a first transparent electrode 21, a second transparent electrode 22, a liquid crystal layer LC, a first alignment layer 31, a second alignment layer 32 and a first electric field uniformizing layer 41. The first transparent substrate 11 may be, for example, a rectangular substrate. The first transparent substrate 11 has edges 11A and 11B, and the edge 11A is adjacent to the edge 11B. The first transparent substrate 11 and the second transparent substrate 12 may be, for example, a glass substrate, a quartz substrate or a plastic substrate, but the present invention is not limited to this and can include other kinds of transparent substrates. The second transparent substrate 12 is disposed opposite to the first transparent substrate 11, and there is a liquid crystal cell gap between the first transparent substrate 11 and the second transparent substrate 12. The liquid crystal cell gap is substantially in a range of 5 micrometers to 60 micrometers, but not limited thereto. The first transparent electrode 21 is disposed on the first transparent substrate 11. The first transparent electrode 21 includes a plurality of first electrode bars 21A. The first electrode bars 21A are parallel to each other and arranged along a first direction D1. The first direction D1 is non-parallel and non-perpendicular to the edge 11A of the first transparent substrate 11. For example, preferably, the included angle between the edge 11A of the first transparent substrate 11 and the first direction D1 is substantially in a range of 4 degrees to 15 degrees, but not limited thereto. The second transparent electrode 22 is disposed on the second transparent substrate 12. The material of both the first transparent electrode 21 and the second transparent electrode 22 may be all kinds of transparent conductive materials with appropriate conductivity. For example, The material of the first transparent electrode 21 and the second transparent electrode 22 may be materials having a light transmittance of more than 85% and a surface resistance in a range of 5 ohm (Ω) to 30Ω—for example, indium tin oxide (ITO) may compose the first transparent electrode 21 and the second transparent electrode 22, but not limited thereto. The liquid crystal layer LC is disposed between the first transparent electrode 21 and the second transparent electrode 22. Specifically speaking, the liquid crystal layer LC is disposed between the first alignment layer 31 and the second alignment layer 32. Preferably, a refractive index difference (Δn) of the liquid crystal layer LC is substantially greater than 0.2. Preferably, a dielectric anisotropy (Δ∈) of the liquid crystal layer LC is substantially larger than 10 so as to achieve better optical performances, but not limited thereto. The first alignment layer 31 is disposed between the first transparent electrode 21 and the liquid crystal layer LC. The first alignment layer 31 is employed to align the adjacent liquid crystal molecules of the liquid crystal layer LC. The first alignment layer 31 has a first alignment direction A1. The first alignment direction A1 is substantially parallel to the first direction D1. The second alignment layer 32 is disposed between the second transparent electrode 22 and the liquid crystal layer LC. The second alignment layer 32 is employed to align the adjacent liquid crystal molecules of the liquid crystal layer LC. The second alignment layer 32 has a second alignment direction A2. The second alignment direction A2 is substantially parallel to the first alignment direction A1. The first alignment direction A1 may be opposite to the second alignment direction A2, but not limited thereto. The first electric field uniformizing layer 41 is disposed between the first alignment layer 31 and the first transparent electrode 21. The first electric field uniformizing layer 41 is preferably a high impedance layer. The sheet resistance of the first electric field uniformizing layer 41 is preferably in a range of 1 kΩ/□ (kilo-ohm/square) to 50 MΩ/□ (mega-ohm/square) so as to provide the desired electric field uniformizing effect, but not limited thereto. The first electric field uniformizing layer 41 preferably includes polymer materials, such as Poly-3,4-Ethylenedioxythiophene (PEDOT), or metal oxide, such as indium gallium zinc oxide (IGZO), titanium oxide (TiO₂) and zinc oxide (ZnO), but not limited thereto.

In this embodiment, the second transparent electrode 22 includes a planar electrode, which fully overlaps the second transparent substrate 12. In addition, the first transparent electrode 21 is disposed on the inner surface of the first transparent substrate 11. The second transparent electrode 22 is disposed on the inner surface of the second transparent substrate 12.

The liquid crystal lenticular lens 1 may be enabled with the following method. A first voltage is applied to a portion of the first electrode bars 21A. A second voltage is applied to another portion of the first electrode bars 21A. A common voltage is applied to the second transparent electrode 22. For example, the first voltage, such as 5 volts, is applied to odd-numbered bars of the first electrode bars 21A. The second voltage, such as 0 volts, is applied to even-numbered bars of the first electrode bars 21A. The common voltage, such as 0 volts, is applied to the second transparent electrode 22. In this condition, the electric field distribution with gradient change is formed along the direction perpendicular to the first direction D1 and between the first transparent electrode 21 and the second transparent electrode 22 so that the refractive index of the liquid crystal layer LC in the direction perpendicular to the first direction D1 varies and produces the lens effect. Furthermore, the first electric field uniformizing layer 41 with high impedance evens out the electric field distribution and thus smoothes the refractive index change of the liquid crystal layer LC, thereby optimizing the lens effect to achieve that of a real lens. Because the first direction D1, along which the first electrode bars 21A are arranged, is non-parallel and non-perpendicular to both the edges 11A and 11B of the first transparent substrate 11, the first direction D1 is non-parallel to the gate line or the data line of the display panel when the liquid crystal lenticular lens 1 is applied to the display panel, thereby avoiding optical issues, such as Moiré phenomenon.

Liquid crystal lenticular lenses are not restricted to the preceding embodiments in the present invention. Other embodiments or modifications of liquid crystal lenticular lenses and two-dimensional and three-dimensional switchable display devices will be detailed in the following description. In order to simplify and show the differences or modifications between the following embodiments and the above-mentioned embodiment, the same numerals denote the same components in the following description, and the similar parts are not detailed redundantly.

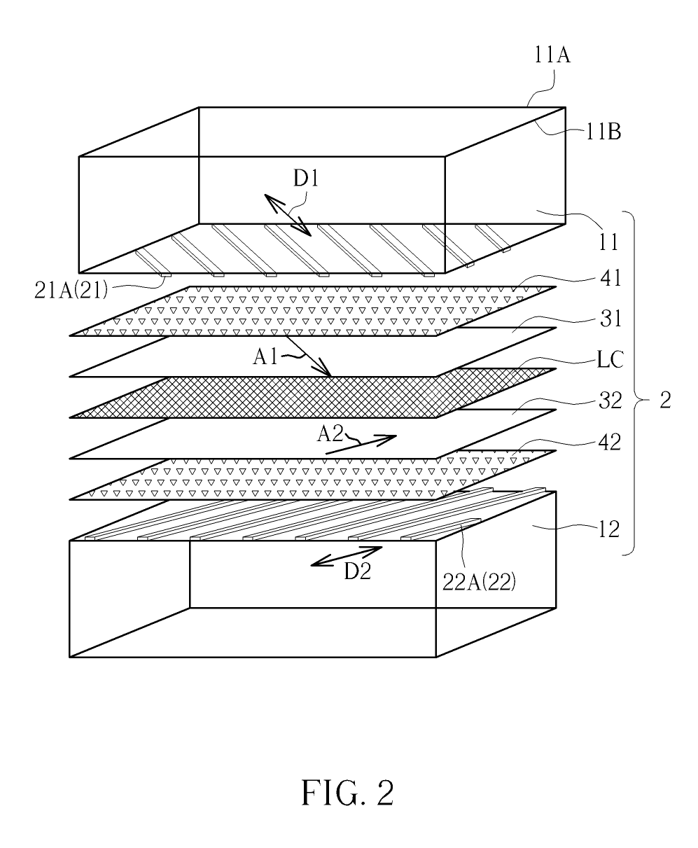

Please refer to FIG. 2. FIG. 2 is a schematic diagram illustrating a liquid crystal lenticular lens according to a second embodiment of the present invention. As shown in FIG. 2, in the liquid crystal lenticular lens 2 of this embodiment, apart from that the first transparent electrode 21 includes a plurality of first electrode bars 21A, the second transparent electrode 22 also includes a plurality of second electrode bars 22A. The second electrode bars 22A are parallel to each other and arranged along a second direction D2. The second direction D2 is non-parallel and non-perpendicular to both the edges 11A and 11B of the first transparent substrate 11. The second direction D2 is not parallel to the first direction D1. For example, preferably, the included angle between the second direction D2 and the edge 11B of the first transparent substrate 11 is substantially in a range of 4 degrees to 15 degrees, but not limited thereto. Moreover, the first transparent electrode 21 is disposed in the inner surface of the first transparent substrate 11, and the second transparent electrode 22 is disposed in the inner surface of the second transparent substrate 12, but not limited thereto. Additionally, the liquid crystal lenticular lens 2 may further include a second electric field uniformizing layer 42. The first electric field uniformizing layer 41 is disposed between the first alignment layer 31 and the first transparent electrode 21. The second electric field uniformizing layer 42 is disposed between the second alignment layer 32 and the second transparent electrode 22. The material properties and function of the second electric field uniformizing layer 42 are similar to those of the first electric field uniformizing layer 41 and will not be redundantly described. In addition, in this embodiment, the first alignment direction A1 of the first alignment layer 31 is not parallel to the second alignment direction A2 of the second alignment layer 32, and the first alignment direction A1 may be opposite to the second alignment direction A2, but not limited thereto.

The liquid crystal lenticular lens 2 may be enabled with the two following methods. The first method is illustrated as follows. A first voltage is applied to a portion of the first electrode bars 21A. A second voltage is applied to another portion of the first electrode bars 21A. A common voltage is applied to the second transparent electrode 22. For example, the first voltage, such as 5 volts, is applied to odd-numbered bars of the first electrode bars 21A. The second voltage, such as 0 volts, is applied to even-numbered bars of the first electrode bars 21A. The common voltage, such as 0 volts, is applied to the second transparent electrode 22. In this condition, the electric field distribution with gradient change is formed along the direction perpendicular to the first direction D1 and between the first transparent electrode 21 and the second transparent electrode 22 so that the refractive index of the liquid crystal layer LC in the direction perpendicular to the first direction D1 varies and produces the lens effect. The second method is illustrated as follows. A first voltage is applied to a portion of the second electrode bars 22A. A second voltage is applied to another portion of the second electrode bars 22A. A common voltage is applied to the first transparent electrode 21. For example, the first voltage, such as 5 volts, is applied to odd-numbered bars of the second electrode bars 22A. The second voltage, such as 0 volts, is applied to even-numbered bars of the second electrode bars 22A. The common voltage, such as 0 volts, is applied to the first transparent electrode 21. In this condition, the electric field distribution with gradient change is formed along the direction perpendicular to the second direction D2 and between the first transparent electrode 21 and the second transparent electrode 22 so that the refractive index of the liquid crystal layer LC in the direction perpendicular to the second direction D2 varies and produces the lens effect.

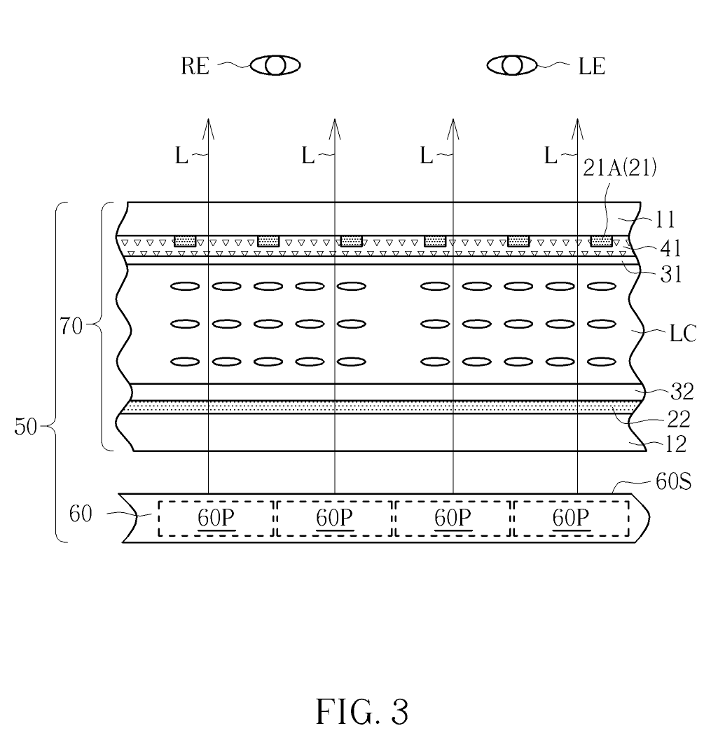

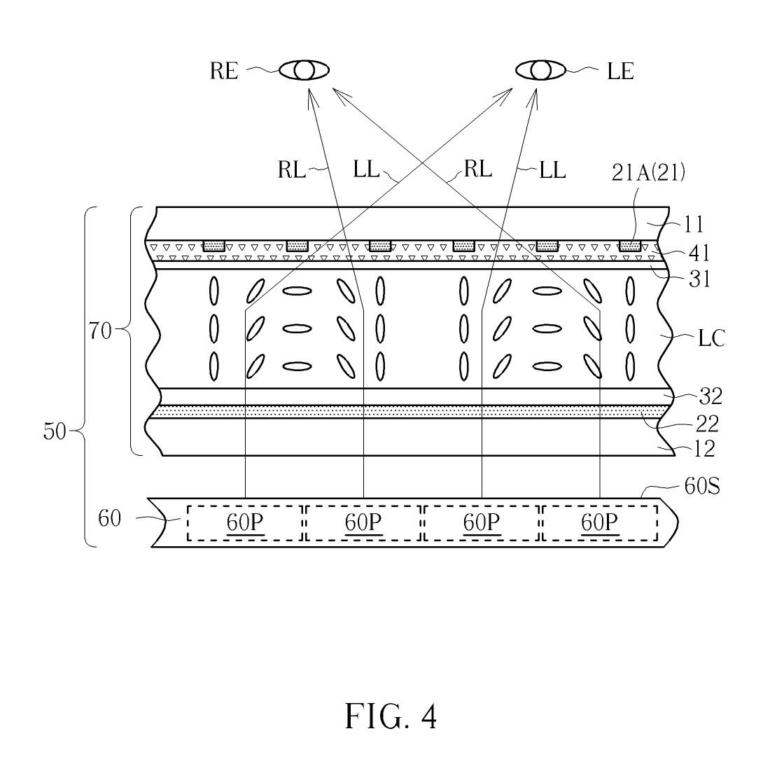

Please refer to FIGS. 3-4 and also refer to FIGS. 1-2. FIGS. 3-4 are schematic diagrams illustrating a two-dimensional and three-dimensional switchable display device according to the first embodiment of the present invention. FIG. 3 is a schematic diagram illustrating a display condition of the two-dimensional and three-dimensional switchable display device in this embodiment under a two-dimensional display mode, while FIG. 4 is a schematic diagram illustrating a display condition of the two-dimensional and three-dimensional switchable display device in this embodiment under a three-dimensional display mode. The two-dimensional and three-dimensional switchable display device 50 in this embodiment includes a display panel 60 and a liquid crystal lenticular lens 70. The display panel 60 has a display surface 60S and a plurality of sub-pixels 60P. The display panel 60 may be various types of display panels, such as liquid crystal display panels, organic light emitting diode (OLED) display panels, electro-wetting display panels, e-ink display panels, plasma display panels, field emission display (FED) panels or other suitable display panels. The liquid crystal lenticular lens 70 is disposed on the display surface 60S of the display panel 60. The liquid crystal lenticular lens 70 may be one of the liquid crystal lenticular lenses described in the embodiments in FIGS. 1 and 2. The components and the operating condition are similar to those in the preceding embodiments and will not be redundantly described. It is worth noting that because both the first direction D1, along which the first electrode bars 21A are arranged, and the second direction D2, along which the second electrode bars 22A are arranged, are non-parallel and non-perpendicular to the edge 11A of the first transparent substrate 11, or because both the first direction D1 and the second direction D2 are non-parallel to the gate line or data line of the display panel 60—that is to say, both the first direction D1 and the second direction D2 are non-parallel to the direction of the long axes or the short axes of the sub-pixels 60P of the display panel 60-optical issues, such as Moiré phenomenon, may be avoided.

As shown in FIG. 3, under the two-dimensional display mode, the liquid crystal lenticular lens 70 is in an off state so that the liquid crystal lenticular lens 70 does not produce the lens effect. In this case, an image L displayed by each of the sub-pixels 60P of the display panel 60 penetrates the liquid crystal lenticular lens 70 without bending and is delivered to both the viewer's left eye LE and right eye RE.

As shown in FIG. 4, under the three-dimensional display mode, the liquid crystal lenticular lens 70 is in an on state so that the liquid crystal lenticular lens 70 produces the lens effect. In this case, a left eye frame LL displayed by a portion of the sub-pixels 60P of the display panel 60 penetrates the liquid crystal lenticular lens 70 and is guided toward the viewer's left eye LE. A right eye frame RL displayed by the other portion of the sub-pixels 60P of the display panel 60 penetrates the liquid crystal lenticular lens 70 and is guided toward the viewer's right eye RE. Accordingly, the left eye frame LL received by the viewer's left eye LE and the right eye frame RL received by the viewer's right eye RE will be analyzed and overlapped in the cerebrum to generating the stereoscopic effect. It is worth noting that if the liquid crystal lenticular lens of the second embodiment in the present invention is selected as the liquid crystal lenticular lens 70, the operating condition can be further modified according to the viewing angle to enhance the stereoscopic effect. For example, if the orientation of the display panel 60 is portrait (i.e. along the vertical direction) under the three-dimensional display mode, the liquid crystal lenticular lens 70 may be enabled by the first method to optimize the lens effect. If the orientation of the display panel 60 is landscape (i.e. along the horizontal direction) under the three-dimensional display mode, the liquid crystal lenticular lens 70 may be enabled by the second method to optimize the lens effect.

In the two-dimensional and three-dimensional switchable display device 50 of this embodiment, the second transparent substrate 12 of the liquid crystal lenticular lens 70 faces the display surface 60S of the display panel 60, but not limited thereto. In other variant embodiments, the first transparent substrate 11 of the liquid crystal lenticular lens 70 may be disposed to face the display surface 60S of the display panel 60.

To sum up, with electric field uniformizing layers, the refractive index change of the liquid crystal layer can be smoothed under the three-dimensional display mode, thereby optimizing the lens effect to achieve that of a real lens. Moreover, both the direction along which the first electrode bars are arranged and the direction along which the second electrode bars are arranged are non-parallel to the direction of the long axes or the short axes of the sub-pixels, and thus optical issues, such as Moiré phenomenon, may be avoided. Furthermore, the appropriate operating condition of the liquid crystal lenticular lens can be determined according to the relative position between the display panel and the viewer to optimize the lens effect and enhance the stereoscopic effect.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal lenticular lens, comprising:
a first transparent substrate, having a plurality of edges;
a second transparent substrate, disposed opposite to the first transparent substrate;
a first transparent electrode, disposed on an inner surface of the first transparent substrate, wherein the first transparent electrode comprises a plurality of first electrode bars, the first electrode bars are parallel to each other and arranged along a first direction, and the first direction is non-parallel and non-perpendicular to the edges of the first transparent substrate;
a second transparent electrode, disposed on an inner surface of the second transparent substrate;
a liquid crystal layer, disposed between the first transparent electrode and the second transparent electrode;
a first alignment layer, disposed between the first transparent electrode and the liquid crystal layer, wherein the first alignment layer has a first alignment direction, and the first alignment direction is parallel to the first direction;
a second alignment layer, disposed between the second transparent electrode and the liquid crystal layer, wherein the second alignment layer has a second alignment direction; and
a first electric field uniformizing layer, disposed between the first alignment layer and the first transparent electrode or between the second alignment layer and the second transparent electrode.

2. The liquid crystal lenticular lens according to claim 1, further comprising a second electric field uniformizing layer, wherein the first electric field uniformizing layer is disposed between the first alignment layer and the first transparent electrode, and the second electric field uniformizing layer is disposed between the second alignment layer and the second transparent electrode.

3. The liquid crystal lenticular lens according to claim 1, wherein the second transparent electrode comprises a planar electrode.

4. The liquid crystal lenticular lens according to claim 3, wherein the first alignment direction is parallel to the second alignment direction.

5. The liquid crystal lenticular lens according to claim 1, wherein the second transparent electrode comprises a plurality of second electrode bars, the second electrode bars are parallel to each other and arranged along a second direction, the second direction is non-parallel and non-perpendicular to the edges of the first transparent substrate, and the second direction is not parallel to the first direction.

6. A two-dimensional and three-dimensional switchable display device, comprising:
a display panel, having a display surface; and
a liquid crystal lenticular lens, disposed on the display surface of the display panel, and the liquid crystal lenticular lens comprising:
a first transparent substrate, having a plurality of edges;
a second transparent substrate, disposed opposite to the first transparent substrate;
a first transparent electrode, disposed on an inner surface of the first transparent substrate, wherein the first transparent electrode comprises a plurality of first electrode bars, the first electrode bars are parallel to each other and arranged along a first direction, and the first direction is non-parallel and non-perpendicular to the edges of the first transparent substrate;
a second transparent electrode, disposed on an inner surface of the second transparent substrate;
a liquid crystal layer, disposed between the first transparent electrode and the second transparent electrode;
a first alignment layer, disposed between the first transparent electrode and the liquid crystal layer, wherein the first alignment layer has a first alignment direction, and the first alignment direction is parallel to the first direction;
a second alignment layer, disposed between the second transparent electrode and the liquid crystal layer, wherein the second alignment layer has a second alignment direction; and
a first electric field uniformizing layer, disposed between the first alignment layer and the first transparent electrode or between the second alignment layer and the second transparent electrode.

7. The two-dimensional and three-dimensional switchable display device according to claim 6, wherein the liquid crystal lenticular lens further comprises a second electric field uniformizing layer, the first electric field uniformizing layer is disposed between the first alignment layer and the first transparent electrode, and the second electric field uniformizing layer is disposed between the second alignment layer and the second transparent electrode.

8. The two-dimensional and three-dimensional switchable display device according to claim 6, wherein the second transparent electrode comprises a planar electrode.

9. The two-dimensional and three-dimensional switchable display device according to claim 8, wherein the first alignment direction is parallel to the second alignment direction.

10. The two-dimensional and three-dimensional switchable display device according to claim 6, wherein the second transparent electrode comprises a plurality of second electrode bars, the second electrode bars are parallel to each other and arranged along a second direction, the second direction is non-parallel and non-perpendicular to the edges of the first transparent substrate, and the second direction is not parallel to the first direction.
